(19) United States
(12) Patent Application Publication
(10) Pub. No.: US 2009/0007987 A1
(43) Pub. Date: Jan. 8, 2009

(54) Tool mount for use in attaching a power tool to a support structure

(75) Inventors: Adam Thomas, Aurora, IL (US); Gary Voong, Chicago, IL (US); Jeremy Burke, Jackson, TN (US); Dan Williams, Chicago, IL (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignees: Credo Technology Corporation, Broadview, IL (US); Robert Bosch GmbH, Stuttgart (DE)

(21) Appl. No.: 11/824,624

(22) Filed: Jul. 2, 2007

(51) Int. Cl. B25H 1/08

(52) U.S. Cl. 144/286.1; 248/205.1

(57) ABSTRACT

A tool mount assembly adapted to be attached to a support structure includes a body and a clamping mechanism configured to secure the body to the support structure. The assembly further includes a first member defining a first internally threaded passage, the first member being movable in relation to the body along a linear path of movement. The assembly also includes a second member defining a second internally threaded passage, the second member being pivotably secured to the body. The body has a first slot defined therein, and the first internally threaded passage is continuously aligned with the first slot during movement of the first member in the linear path of movement. In addition, the body has a second slot defined therein, and the second internally threaded passage is continuously aligned with the second slot during movement of the second member in an arcuate path of movement.

### BACKGROUND

The present disclosure relates generally to mounts for tools, and particularly to tool mounts that are utilized to attach a power tool to a support structure.

It is desirable to mount a power tool such as a miter saw to a support structure such as a work bench. However, miter saws are not typically configured to be directly mounted to certain support structures such as portable workbenches. In order to address this need, various tool mounts have been designed to facilitate attachment of a power tool to a portable workbench. In particular, a pair of tool mounts is attached to a work support in a spaced apart fashion. Thereafter, one side of a power tool is attached to one of the tool mounts, while the other side of the power tool is attached to the other tool mount. In this way, the power tool is rigidly secured to the work support for subsequent use by an operator.

One challenge that designers of tool mounts encounter arises due to the non-uniformity in mounting features of the power tools among different manufacturers. Significantly, the fastener hole patterns on the bottom side of power tools that are used for mounting the power tool to a work support vary substantially from manufacturer to manufacturer. Thus, some power tools are not readily attachable to certain tool mounts due to misalignment of their fastener hole patterns with the corresponding hole pattern of the particular tool mounts. Thus, a goal of tool mount designers is to design their tool mounts to be effective to attach power tools made by many different manufacturers to a work support with a single tool mount design.

Another goal of tool mount designers is to design their tool mounts so that attachment of the power tool to the work support is relatively quick and easy. Still another goal of tool mount designers is to design their tool mounts to provide added safety during the assembly and disassembly of the power tool to the work support. Yet another goal of tool mount designers is to design their tool mounts to provide added safety during use of the power tool while it is attached to the work support.

What is needed therefore is a tool mount that is effective to attach power tools made by many different manufacturers to a work support with a single tool mount design. What is also needed is a tool mount that facilitates attachment of the power tool to the work support in a relative quick and easy manner. What is further needed is a tool mount that provides added safety during the assembly and disassembly of the power tool to the work support. What is additionally needed is a tool mount that provides added safety during use of the power tool while it is attached to the work support.

### SUMMARY

In accordance with one embodiment of the disclosure, there is provided a tool mount assembly adapted to be attached to a support structure. The assembly includes a body and a clamping mechanism configured to secure the body to the support structure. The assembly further includes a first member defining a first internally threaded passage, the first member being movable in relation to the body along a linear path of movement. The assembly also includes a second member defining a second internally threaded passage, the second member being pivotably secured to the body. The body has a first slot defined therein, and the first internally threaded passage is continuously aligned with the first slot during movement of the first member in the linear path of movement. In addition, the body has a second slot defined therein, and the second internally threaded passage is continuously aligned with the second slot during movement of the second member in an arcuate path of movement.

Pursuant to another embodiment of the disclosure, there is provided a tool mount assembly adapted to be attached to a support structure. The assembly includes a body having a first slot defined therein. The assembly further includes a clamping mechanism configured to secure the body to the support structure. Also, the assembly includes a first member defining a first internally threaded passage, the first member being movable in relation to the body along a linear path of movement, and the first internally threaded passage being continuously aligned with the first slot during movement of the first member in relation to the body along the linear path of movement. In addition, the assembly includes a second member defining a second internally threaded passage, the second member being movable in relation to the body.

In accordance with yet another embodiment of the disclosure, there is provided a tool mount assembly adapted to be attached to a support structure. The assembly includes an elongate body defining a width and a length. The assembly further includes a clamping mechanism configured to secure the body to the support structure. In addition, the assembly includes a first member including a first coupling component, the first member being movable in relation to the body in a lengthwise direction in relation to the body. The assembly also includes a second member including a second coupling component, the second member being movable in relation to the body in a widthwise direction in relation to the body.

### BRIEF DESCRIPTION OF THE DRAWINGS

FIG. 1 is an exploded, perspective view of the tool mounts, the power tool, and the support structure according to the present disclosure;

FIG. 2 is a perspective view of part of the power tool of FIG. 1;

FIG. 3 is a cross sectional view of the rail member of the rail assembly of the support structure of FIG. 1;

FIG. 4 is an exploded, perspective view of one of the tool mounts of FIG. 1;

FIG. 5 is a perspective view of the tool mount of FIG. 4;

FIGS. 6-7 are cross sectional views of the tool mount of FIG. 4 showing the tool mount in the process of being clamped to the rail assembly of the support structure of FIG. 1;

FIG. 8 is a top elevational view of the tool mount of FIG. 4 with the clamp mechanism in an unclamped position,

FIG. 9 is a cross sectional view of the tool mount of FIG. 8;

FIG. 10 is a top elevational view of the tool mount of FIG. 4 with the clamp mechanism in a clamped position,

FIG. 11 is a cross sectional view of the tool mount of FIG. 10

FIG. 12 is a cross sectional view of one of the tool mounts of FIG. 1;

FIG. 13 is a perspective view of an alternative embodiment of the body of one of the tool mounts of FIG. 1;

FIG. 14 is a rear elevational view of the body of FIG. 13;

FIG. 15 is a perspective view of the stationary jaw of the tool mount of FIG. 4

FIG. 16 is a side elevational view of the stationary jaw of FIG. 15;

FIG. 16A is bottom elevational view of stationary jaw of FIG. 15;

FIG. 17 is a perspective view of the movable jaw of the tool mount of FIG. 4;

FIG. 18 is another perspective view of the movable jaw of FIG. 17;

FIG. 19 is a side elevational view of the movable jaw of FIG. 17;

FIG. 20 is a perspective view of the handle of the clamping mechanism of the tool mount of FIG. 4;

FIG. 21 is another perspective view of the handle of FIG. 20;

FIG. 22 is a top elevational view of the handle of FIG. 20;

FIG. 23 is an elevational view of the link of the clamping mechanism of the tool mount of FIG. 4;

FIG. 24 is a perspective view of the link pin of the clamping mechanism of the tool mount of FIG. 4;

FIG. 25 is a cross sectional view of the hinge pins of the clamping mechanism of the tool mount of FIG. 4;

FIG. 26 is a perspective view of the locking member of the clamping mechanism of the tool mount of FIG. 4;

FIG. 27 is a cross sectional view of the locking member of FIG. 26;

FIG. 28 is a side elevational view of the locking member of FIG. 26;

FIG. 29 is a top elevational view of a movable member of the tool mount of FIG. 4;

FIG. 30 is a perspective view of the movable member of FIG. 29;

FIG. 31 is a cross sectional view of the pin of the tool mount of FIG. 4;

FIG. 32 is a perspective view of another movable member of the tool mount of FIG. 4;

FIG. 33 is a top elevational view of the movable member of FIG. 32;

FIG. 34 is a cross sectional view taken along the line 34-34 of FIG. 33;

FIG. 35 is a side elevational view of the movable member of FIG. 32;

FIG. 36 is a perspective view of another movable member of the tool mount of FIG. 4 which is an alternative embodiment of the movable member of FIGS. 32-35;

FIG. 37 is a top elevational view of the movable member of FIG. 36;

FIG. 38 is a cross sectional view taken along the line 38-38 of FIG. 37;

FIG. 39 is a side elevational view of the movable member of FIG. 36;

FIG. 40 is a perspective view of an alternative embodiment of a retainer structure of the tool mount of FIG. 4; and

FIG. 41 is another perspective view of the retainer structure of FIG. 40.

### DESCRIPTION OF THE PREFERRED EMBODIMENTS

While the tool mount described herein is susceptible to various modifications and alternative forms, specific embodiments thereof have been shown by way of example in the drawings and will herein be described in detail. It should be understood, however, that there is no intent to limit the tool mount to the particular forms disclosed, but on the contrary, the intention is to cover all modifications, equivalents, and alternatives falling within the spirit and scope of the invention as defined by the appended claims.

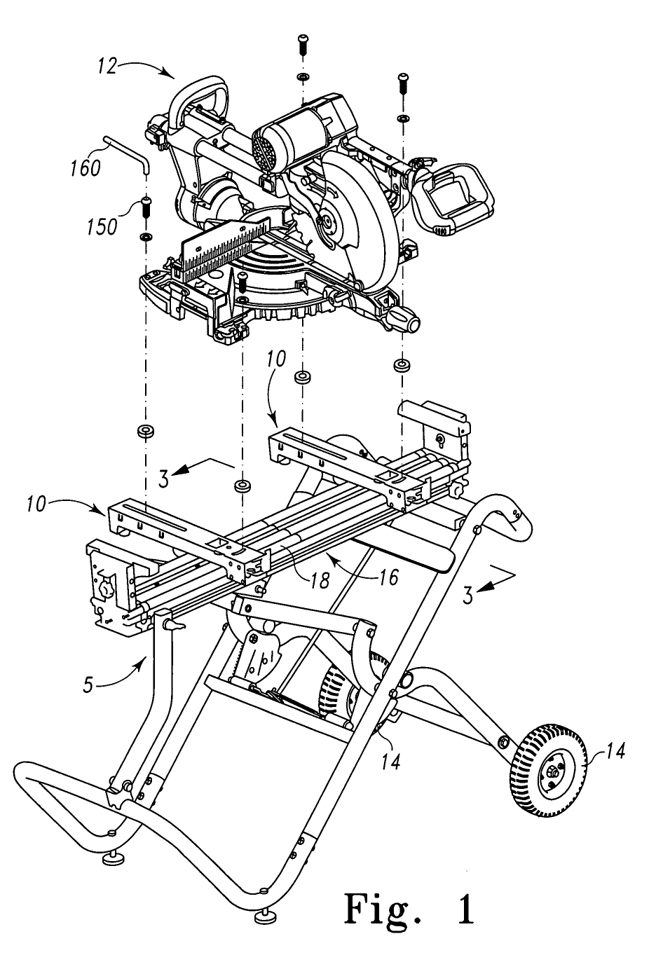

Referring now to FIG. 1, there is shown a support structure 5 to which is secured a pair of tool mounts 10. The tool mounts 10 are configured to facilitate attachment of a power tool 12 to the support structure 5. The support structure 5 is, by way of example, a portable workbench as shown in FIG. 1. In an alternative embodiment, the support structure may be a stationary workbench. The power tool 12 is, by way of example, a miter saw as also shown in FIG. 1. Alternatively, the power tool may be any other power tool such as a router. When the tool mounts 10 are secured to the support structure 5 and the power tool 12 is secured to the pair of tool mounts 10, then the power tool 12 is rigidly fixed in relation to the support structure 5 for use by an operator of the power tool 12.

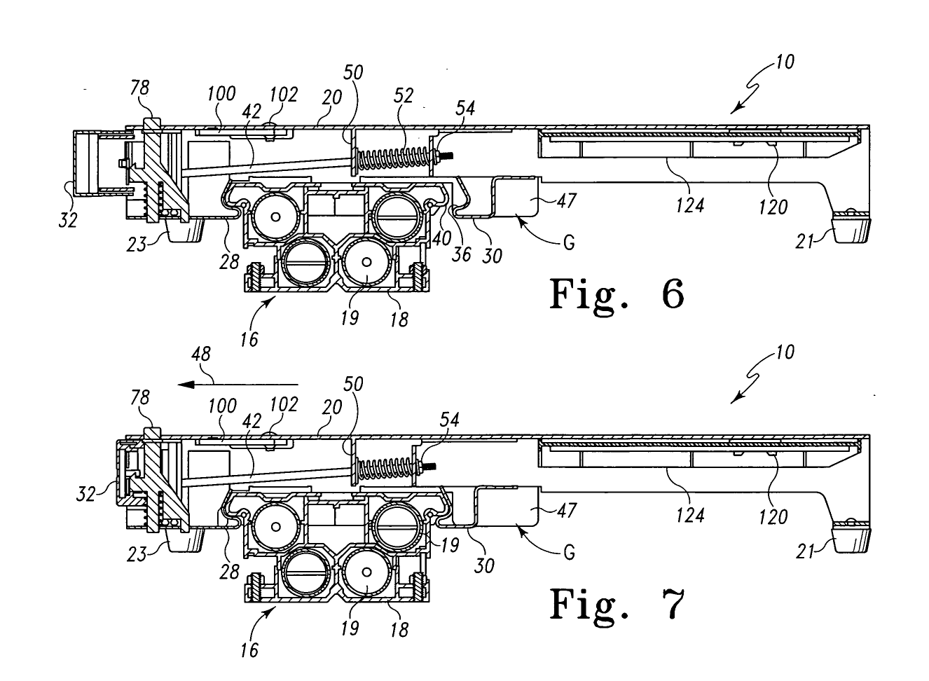

The support structure 5 includes a pair of wheels 14 to enable a user to readily move the support structure 5 from one location to another. The support structure 5 includes a rail assembly 16 having a rail member 18 (see also FIG. 3) to which the tool mounts 10 are attached. The rail member 18 defines a number of cavities 17 in which a number of elongate support members 19 extend. (See FIGS. 6-7.)

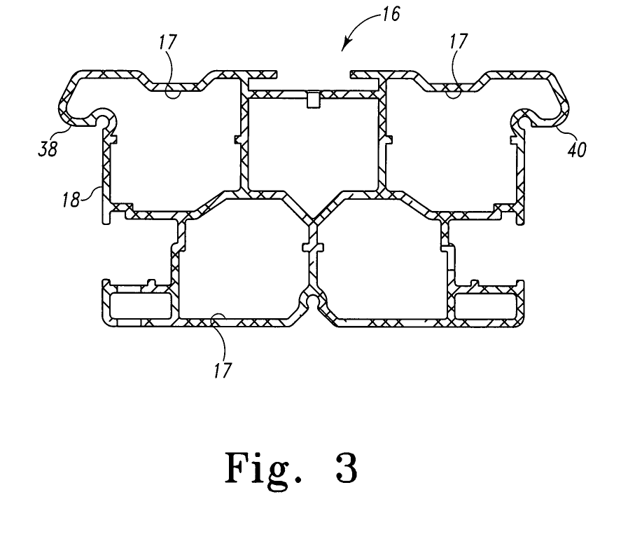

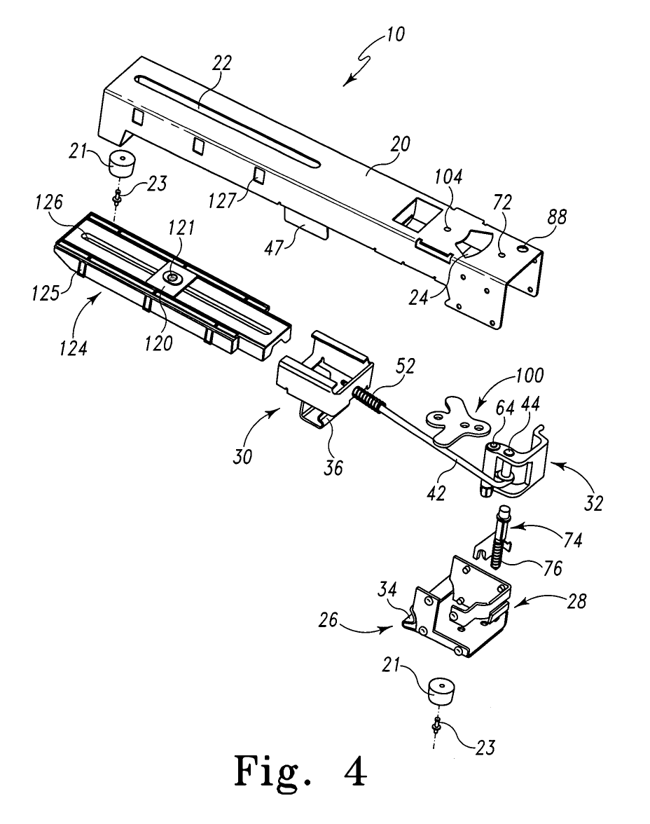

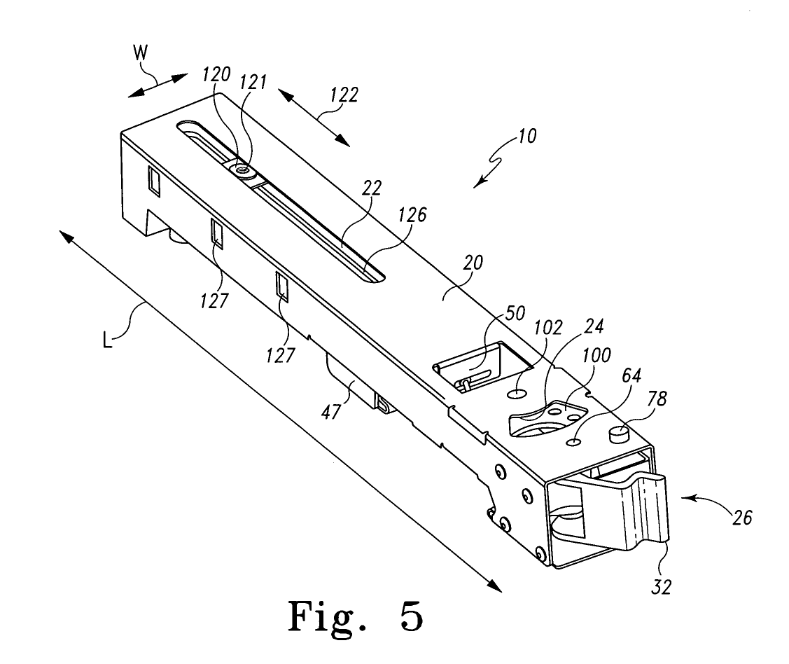

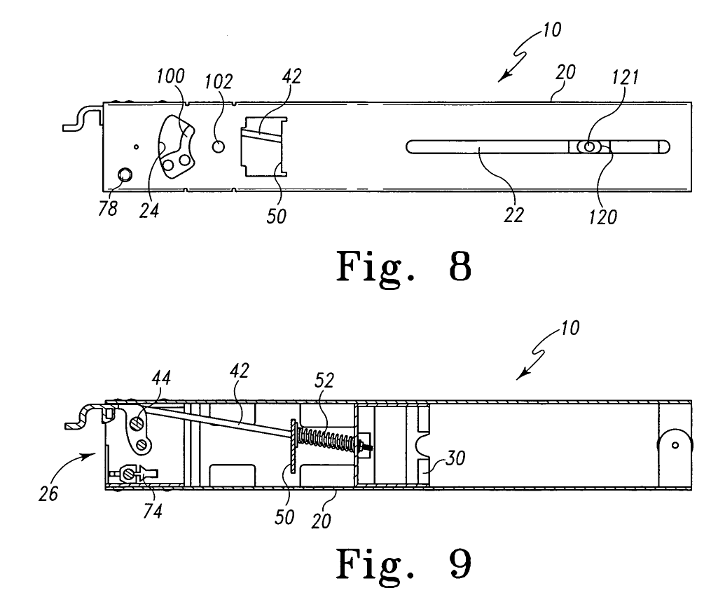

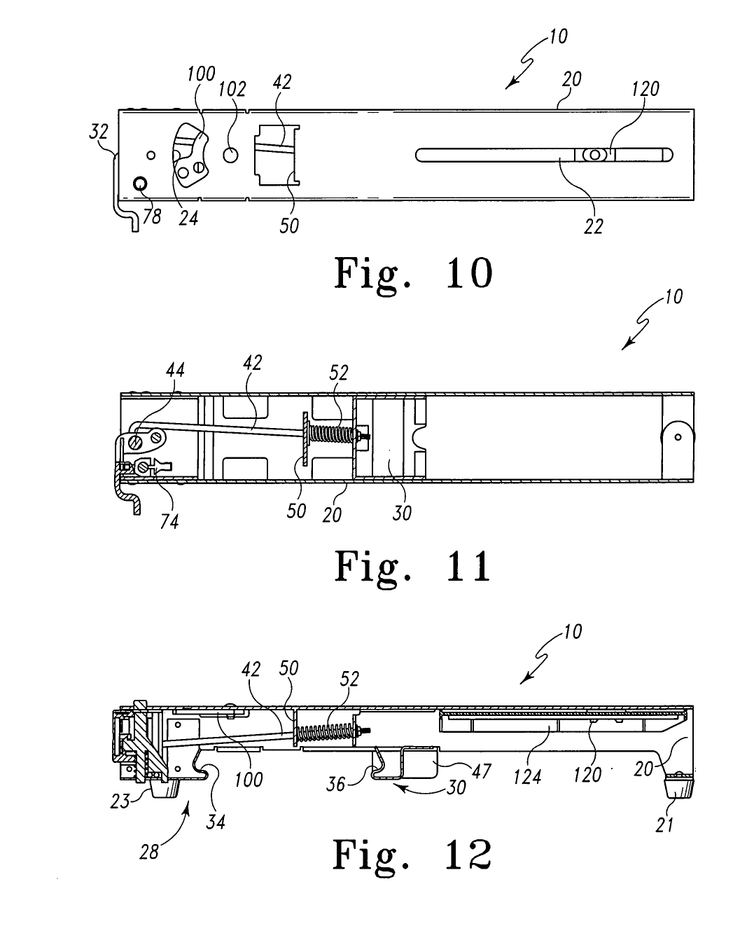

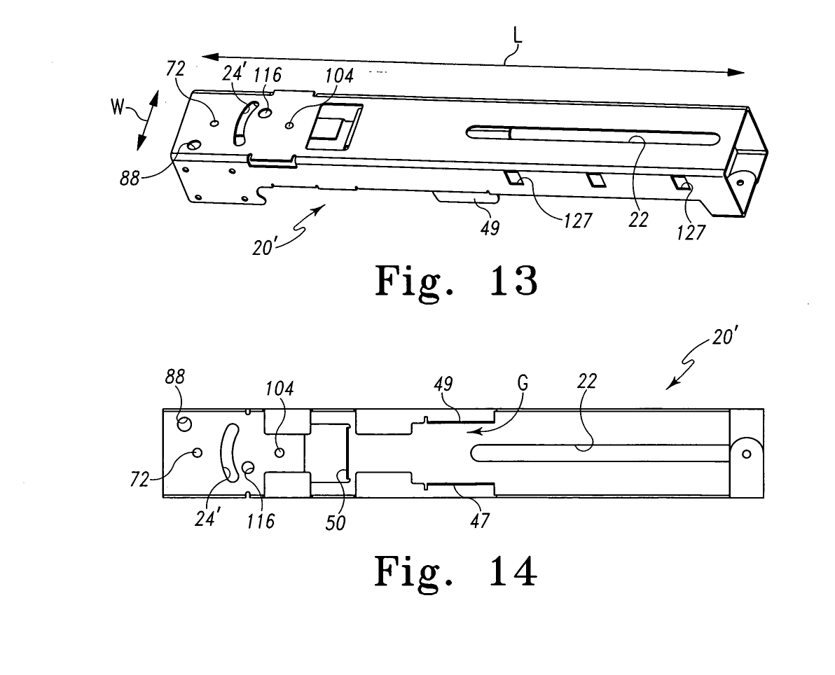

The pair of tool mounts 10 are identical in construction and operation to each other. Thus, only one of the tool mounts 10 will be described in detail below. FIGS. 4-12 show various views of the tool mount 10. The tool mount 10 includes an elongate body 20. A rubber foot 21 is secured to the bottom of the body 20 near each end of the body 20 with a fastener 23. The body 20 defines a lengthwise direction as indicated by arrow L and a widthwise direction as indicated by arrow W. (See FIG. 5.) The body 20 has a slot 22 and a slot 24 defined therein. The slot 22 extends in a linear manner, while the slot 24 extends in an arcuate manner. (See FIG. 8.) It should be appreciated that the slot 22 extends in the lengthwise direction, and the slot 24 extends in the widthwise direction. FIGS. 13-14 show an alternative embodiment of the body. The slot 24′ of the body 20′ is narrower than the slot 24 of the body 20 shown in FIGS. 4-5 and 8-10. However, all other aspects of the body 20′ is essentially the same as the body 20.

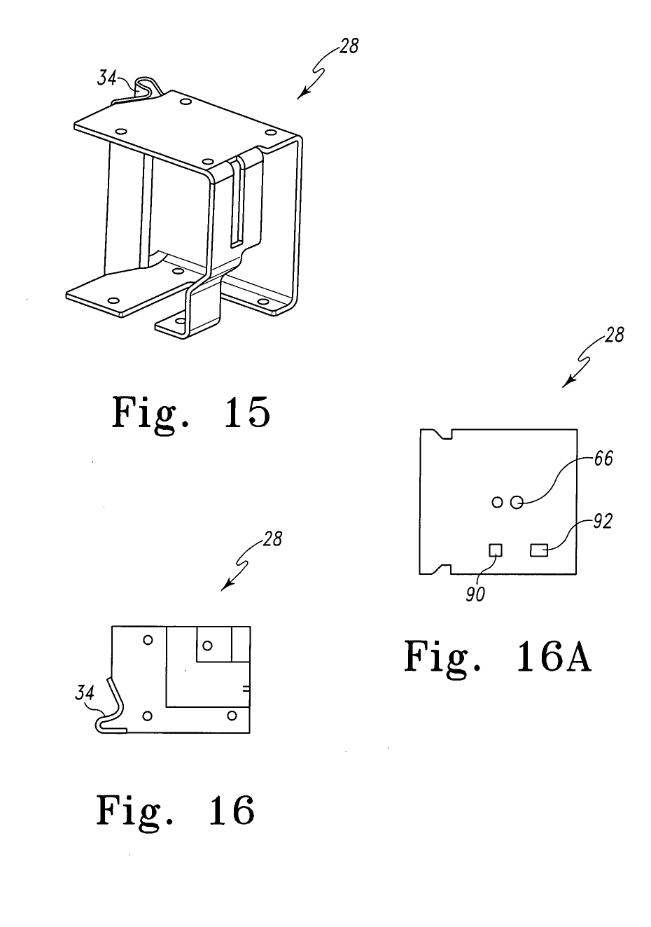

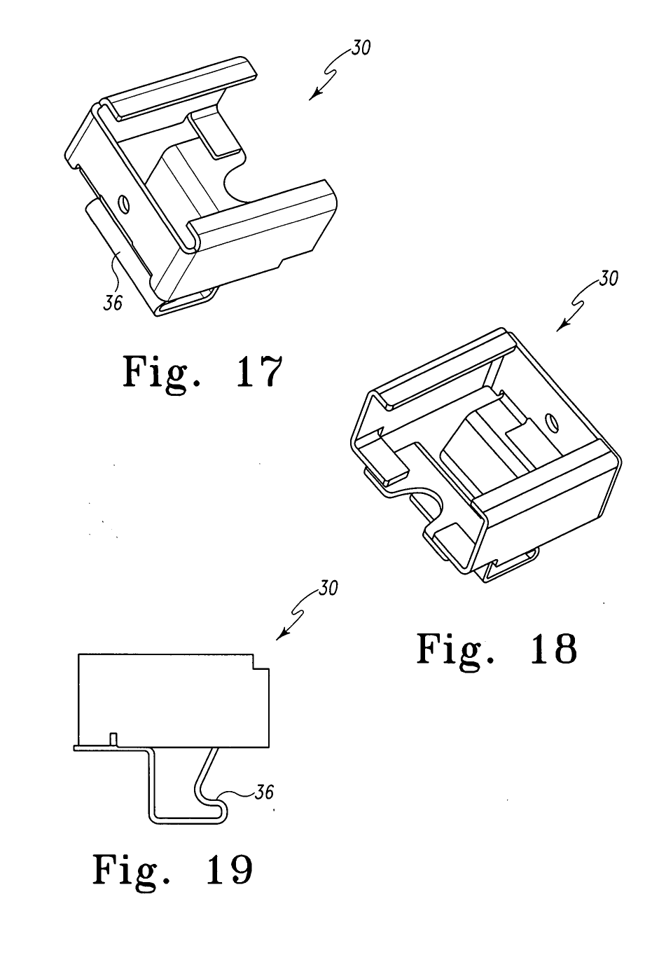

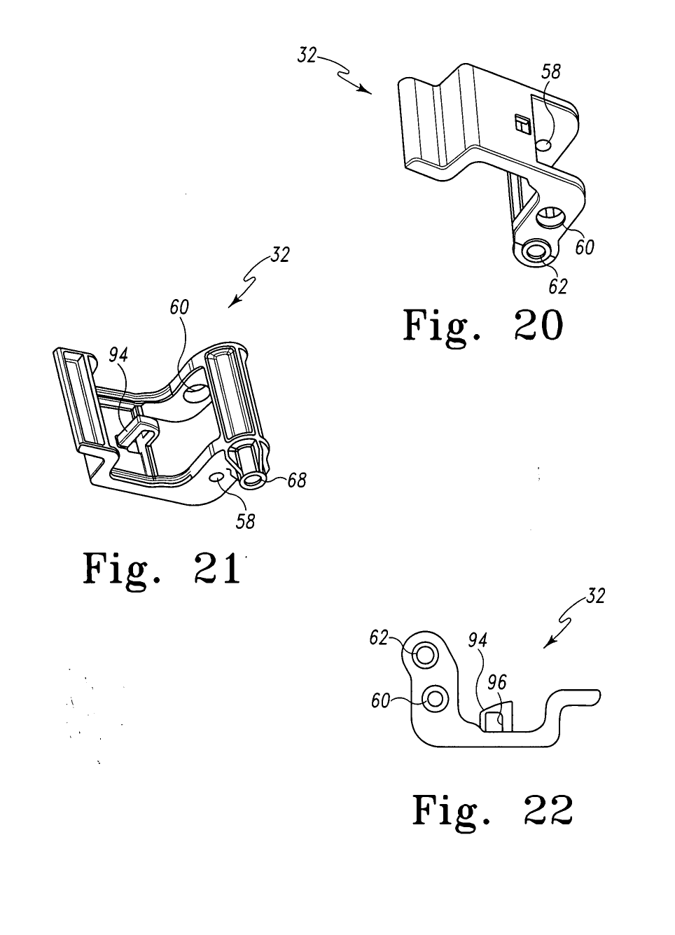

The tool mount 10 further includes a clamping mechanism 26 that is configured to secure the body 20 to the support structure 5. The clamping mechanism 26 is shown in an exploded view in FIG. 4. The clamping mechanism 26 includes a jaw 28 that is secured in fixed relation to the body 20. The clamping mechanism 26 further includes another jaw 30 that is movable in relation to the body 20. The jaw 28 is shown in more detail in FIGS. 15, 16, and 16A while the jaw 30 is shown in more detail in FIGS. 17-19. The clamping mechanism 26 further includes a handle 32 that is pivotably attached to the body 20. The handle 32 is shown in more detail in FIGS. 20-22. Pivoting of the handle 32 from its position shown in FIG. 9 to its position shown in FIG. 11 causes the jaw 30 to move toward the jaw 28. In particular, pivoting of the handle 32 from its position shown in FIG. 9 to its position shown in FIG. 11 causes the jaw 30 to move from its position shown in FIG. 6 to its position shown in FIG. 7. Note that when the jaws 28, 30 are in their relative position as shown in FIG. 6, the gap between the jaws 28, 30 is sufficiently large for the tool mount 10 to be pivoted and then lifted away from the rail member 18 of the rail assembly 16. In contrast, when the jaws 28, 30 are in their relative position as shown in FIG. 7, the gap between the jaws 28, 30 is reduced in relation to the gap shown in FIG. 6 such that the rail member 18 is securely clamped between the jaws 28 and 30. As such, the tool mount 10 is securely attached to of the rail assembly 16.

The jaw 28 includes a clamping surface 34, while the jaw 30 includes a clamping surface 36. The rail member 18 includes a clamping surface 38 and another clamping surface 40. When the jaws 28, 30 are in their relative position as shown in FIG. 7 in which the rail member 18 is clamped between the jaws 28 and 30 (i) the clamping surface 34 of the jaw 28 is held in contact with the clamping surface 38 of the rail member 18, and (ii) the clamping surface 36 of the jaw 30 is held in contact with the clamping surface 40 of the rail member 18.

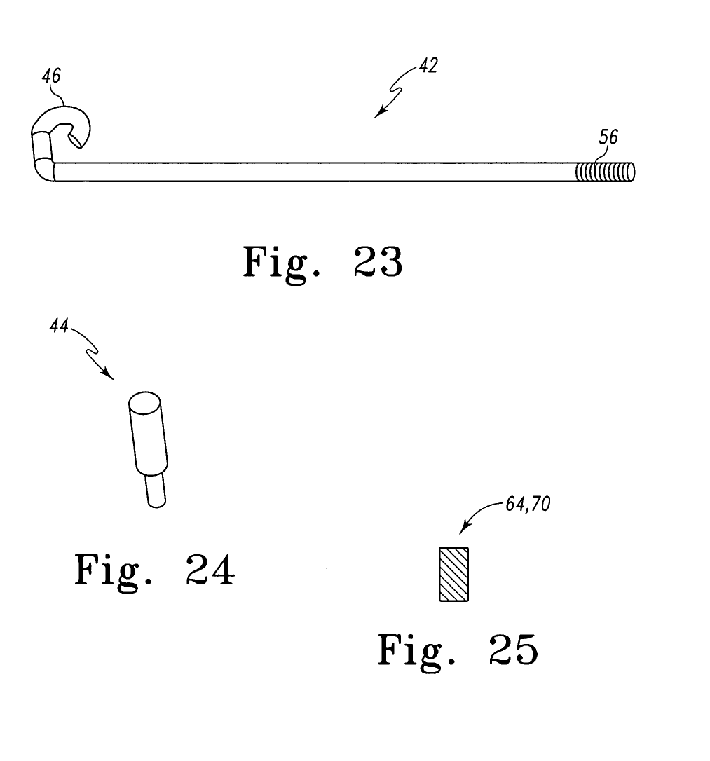

The clamping mechanism 26 further includes a link 42 (FIG. 23), while the handle 32 includes a link pin 44 (FIG. 24). The link pin 44 extends between an opening 58 and an opening 60 defined in the handle 32. (See FIG. 20-22.) The link pin 44 is carried by the handle 32 during pivoting of the handle 32 in relation to the body 20. A looped end portion 46 of the link 42 is positioned around the link pin 44 as shown in FIG. 4. Thus, pivoting of the handle 32 causes the link 42 to move in the direction of arrow 48 (see FIG. 7) from its position shown in FIG. 6 to its position shown in FIG. 7. In turn, movement of the link 42 in the direction of arrow 48 causes movement of the jaw 30 in the direction arrow 48.

The body 20 further includes a first downwardly extending blocking member 47 and a second downwardly extending blocking member 49. The blocking members 47 and 49 are spaced apart from each other to define a gap G. It should be appreciated that during movement of the clamping surface 36 of the jaw 30 from its position shown in FIG. 6 to its position shown in FIG. 7, (i) the clamping surface 36 is positioned within the gap G for a first extent of movement, and thereafter (ii) the clamping surface 36 is positioned outside of the gap G for a second extent of movement. FIG. 6 shows the clamping surface 36 positioned within the gap G, while FIG. 7 shows the clamping surface 36 spaced apart from the gap G.

The body 20 further includes a downwardly extending stop 50. The clamping mechanism 26 further includes a spring 52 positioned around the link 42 and interposed between the stop 50 and the jaw 30. A washer (not shown) is interposed between the stop 50 and the spring 52. A nut 54 is threaded onto a threaded end portion 56 of the link 42 to secure the jaw 30 to the link 42. The spring 52 is configured and positioned to bias the jaw 30 to its position in FIG. 6 absent application of force thereto. The nut 54 may be rotated in relation to the link 42 to adjust the magnitude of spring bias generated by the spring 52. In addition, adjustment of the nut 54 causes the unclamped position of the jaw 30 to be adjusted. It should be appreciated that rotation of the nut 54 in relation to the link 42 also adjusts the magnitude of clamping force when the tool mount 10 is clamped to the rail member 18.

The handle 32 further defines a recess 62 in which a hinge pin 64 is partially positioned. (See FIG. 25.) The jaw 28 further includes an opening 66 defined therein. The handle 32 further defines another recess 68 in which another hinge pin 70 is partially positioned. The hinge pin 64 is further positioned in an opening 72 defined by the body 20, while the hinge pin 70 is further positioned in the opening 66 defined by the jaw 28. The handle 32 pivots about an axis defined by the hinge pins 64, 70.

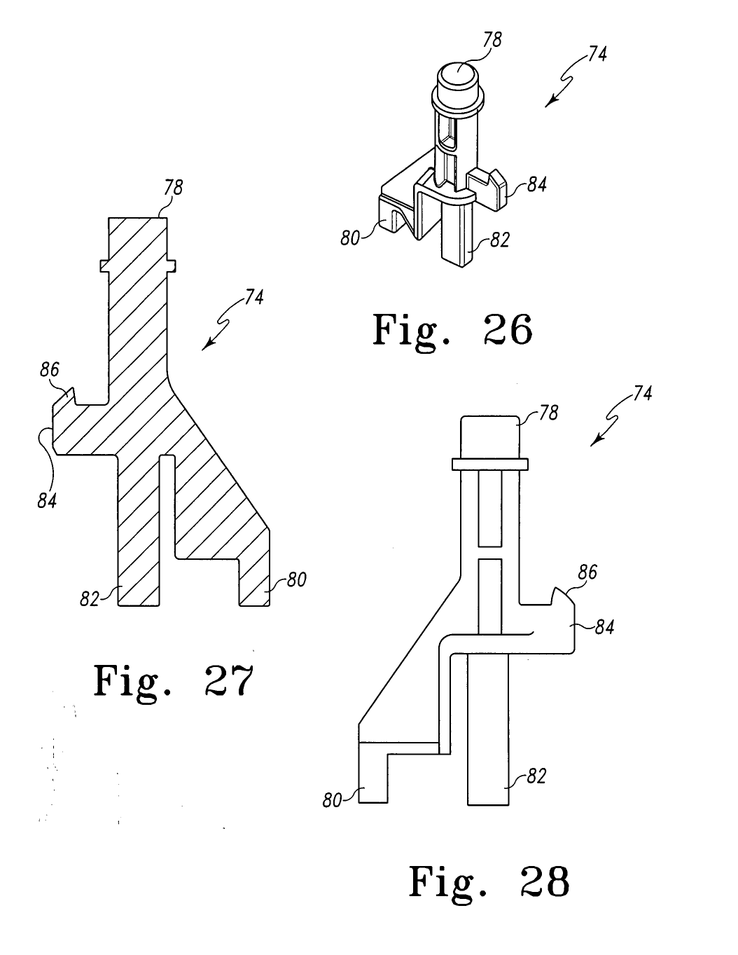

The clamping member 26 further includes a locking member 74 movably secured to the body 20. The locking member is shown in more detail in FIGS. 26-28. The locking member 74 is spring biased toward an upward position by a spring 76. (See FIG. 4.) The locking member 74 includes a knob 78, a post 80, a post 82, and an arm 84 that carries a tang 86. The body 20 further defines an opening 88. The jaw 28 further defines openings 90, 92. The knob 78 extends through the opening 88, while the posts 80, 82 respectively extend through the openings 90, 92.

The handle 32 includes a catch 94 having that defines an opening 96 extending therethrough. When the handle 32 is pivoted from its position shown in FIG. 6 (and FIG. 9) to its position shown in FIG. 7 (and FIG. 11), the catch 94 urges the locking member 74 downwardly against the spring bias of the spring 76 until the tang 86 becomes aligned with the opening 96 in the catch 94. Alignment of the tang 86 with the opening 96 of the catch 94 causes the locking member 74 to spring upwardly thereby causing the tang 86 to become positioned with the opening 96 thereby locking the handle 32 in the position shown in FIG. 7. When the handle 32 is locked in the position shown in FIG. 7, the clamping mechanism 26 is locked in the clamped position as shown in FIG. 7.

In order to unlock the clamping mechanism 26 from its position shown in FIG. 7, the knob 78 is urged downwardly against the spring bias of spring 76 thereby moving the tang 86 out of the opening 96 of the catch 94. Thereafter, the user may pivot the handle 32 from its position shown in FIG. 7 (and FIG. 11) to its position shown in FIG. 6 (and FIG. 9). Such movement of the handle 32 causes the jaw 30 to move away from jaw 28 thereby releasing the rail member 18 from its clamped condition.

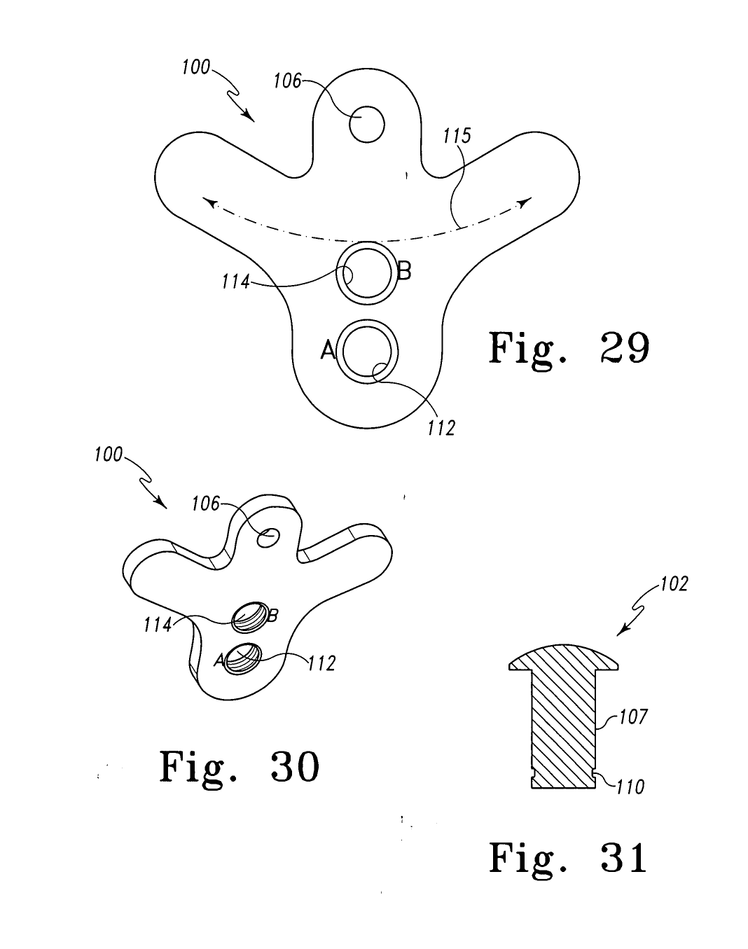

The tool mount 10 further includes a movable member 100 that is pivotably secured to the body 20. The movable member 100 is shown in detail in FIGS. 29-30. The movable member 100 is pivotably coupled to the body 20 by a pin 102. (See FIG. 31.) In particular, the body 20 has defined therein an opening 104 through which the pin 102 extends. The pin 102 further extends through an opening 106 defined in the movable member 100. A clip (not shown) is positioned within a groove 110 defined on a shaft 107 of the pin 102 to retain the above components together.

The movable member 100 further has defined therein a threaded passage 112 and a threaded passage 114. The threaded passage 112 is aligned with the slot 24 defined in the body 20 as shown in FIG. 5. Moreover, the threaded passage 114 is aligned with the slot 24 defined in the body 20 as shown in FIG. 5. In the alternative embodiment of the body 20′ shown in FIGS. 13-14, the threaded passage 112 is aligned with the slot 24′. Further, in the alternative embodiment of the body 20′, the movable member may be positioned so that the threaded passage 114 is aligned with an opening 116 defined in the body 20′. It should be appreciated that during pivoting of the movable member 100, both of the threaded openings 112, 114 are moved in an arcuate path of movement as depicted by arrow 115 in FIG. 29. Note that during movement of threaded openings 112, 114 in an arcuate path of movement, both of the threaded openings 112, 114 are continuously aligned with the slot 24 defined in the body 20. In the alternative embodiment of the body 20′, it should be appreciated that during movement of the threaded opening 112 in an arcuate path of movement, the threaded opening 112 is continuously aligned with the slot 24′.

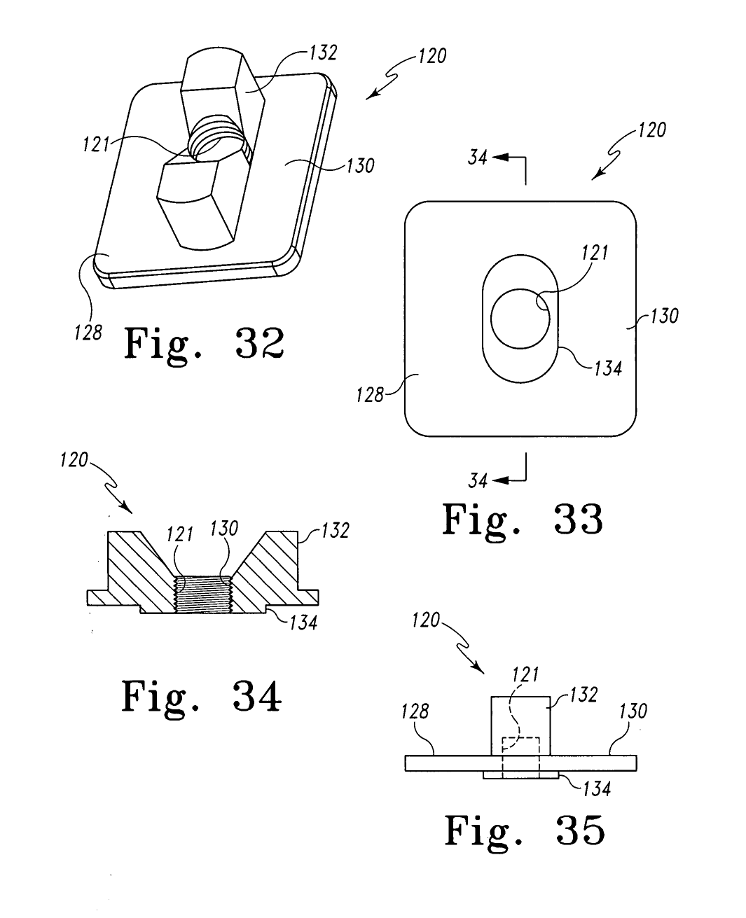

The tool mount 10 further includes a movable member 120 that is movable in relation to the body 20 in a linear path of movement as depicted by arrow 122. (See FIG. 5.) The movable member 120 is shown in detail in FIGS. 32-35. The tool mount 10 also includes a retainer structure 124 (see FIG. 4) that is secured to the body 24. The retainer structure 124 has defined therein a slot 126. The movable member 120 is slidably retained between the body 20 and the retainer structure 124. The movable member 120 has a threaded passage 121 defined therein. During movement of the movable member 120 in the linear path of movement, the threaded passage 121 is continuously aligned with both (i) the slot 24 of the body 20, and (ii) the slot 126 of the retainer structure 124.

The retainer structure 124 includes a plurality of tabs 125. The body 20 has defined therein a plurality of openings 127. In order to secure the retainer structure 124 to the body 20, the plurality of tabs 125 are respectively received in the plurality of openings 127 as shown in FIGS. 5, 9, and 11.

The movable member 120 includes (i) a lateral portion 128 positioned on one side of the threaded passage 121, and (ii) a lateral portion 130 positioned on an opposite side of the threaded passage 121. Both lateral portions 128,130 are interposed between the body 20 and the retainer structure 124 during movement of the movable member 120 in its linear path of movement.

The movable member 120 further includes a follower 132 and a follower 134. The internally threaded passage 121 extends through both the follower 132 and the follower 134. During movement of the movable member 120 in its linear path of movement, (i) the follower 134 is positioned in the slot 22 of the body, and (ii) the follower 132 is positioned in the slot 126 of the retainer structure 124.

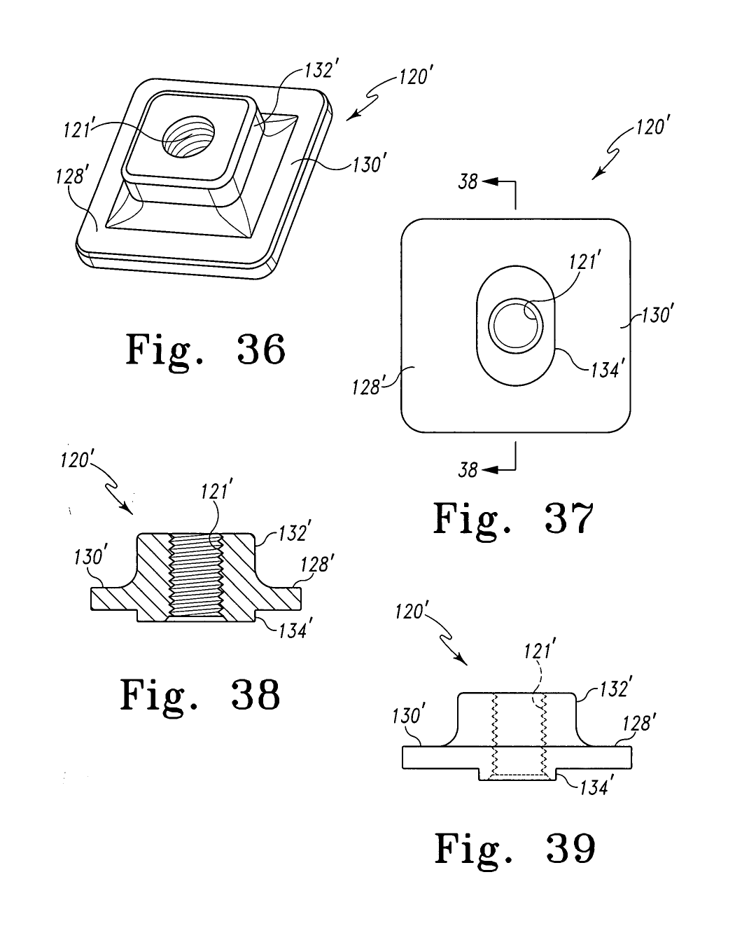

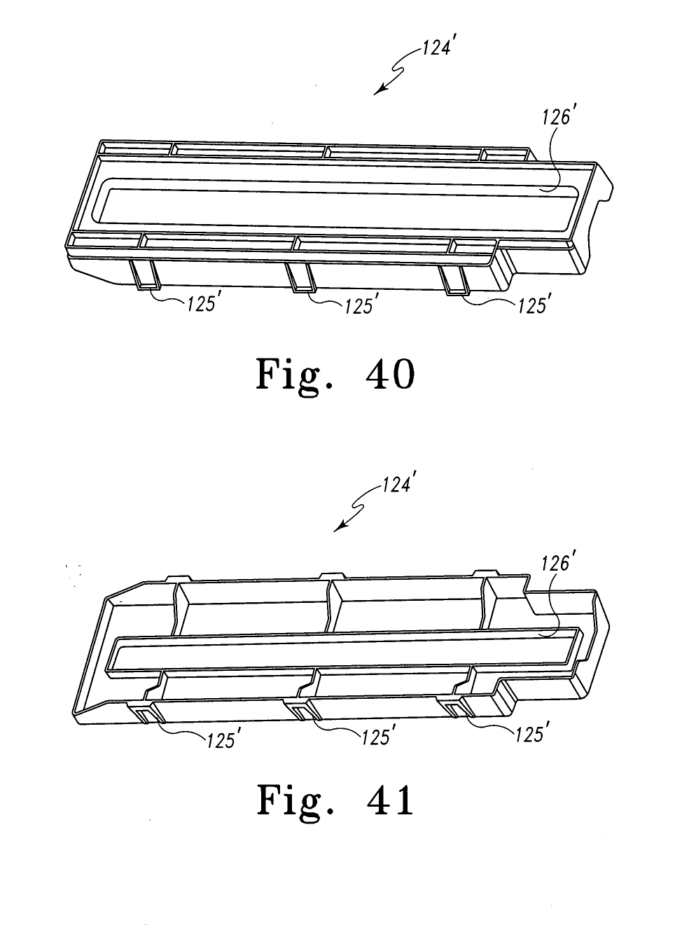

An alternative embodiment of the movable member 120′ is shown in FIG. 36-39. The movable member 120′ is used in an identical manner to the movable member 120. The movable member 120′ includes a threaded passage 121′. The movable member 120′ includes (i) a lateral portion 128′ positioned on one side of the threaded passage 121′, and (ii) a lateral portion 130′ positioned on an opposite side of the threaded passage 121′. The movable member 120′ further includes a follower 132′ and a follower 134′. The internally threaded passage 121′ extends through both the follower 132′ and the follower 134′. The movable member 120′ has a wider follower member 132′ in comparison to the follower member 132 of the movable member 120. Thus, an alternative embodiment of the retainer structure 124′ (see FIGS. 40-41) is substituted for the retainer structure 124 when the movable member 120′ is incorporated into the tool mount 10. The retainer structure 124′ is shown in detail in FIGS. 40-41. The retainer structure 124′ has defined therein a slot 126′ that receives the wider follower 132′. The retainer structure 124′ has a plurality of tabs 125′ that are configured to be respectively received into a plurality of openings 127 defined in the body 20 (or the body 20′). The retainer structure 124′ is used in the tool mount 10 in exactly the same manner that the retainer structure 124 is used in the tool mount 10.

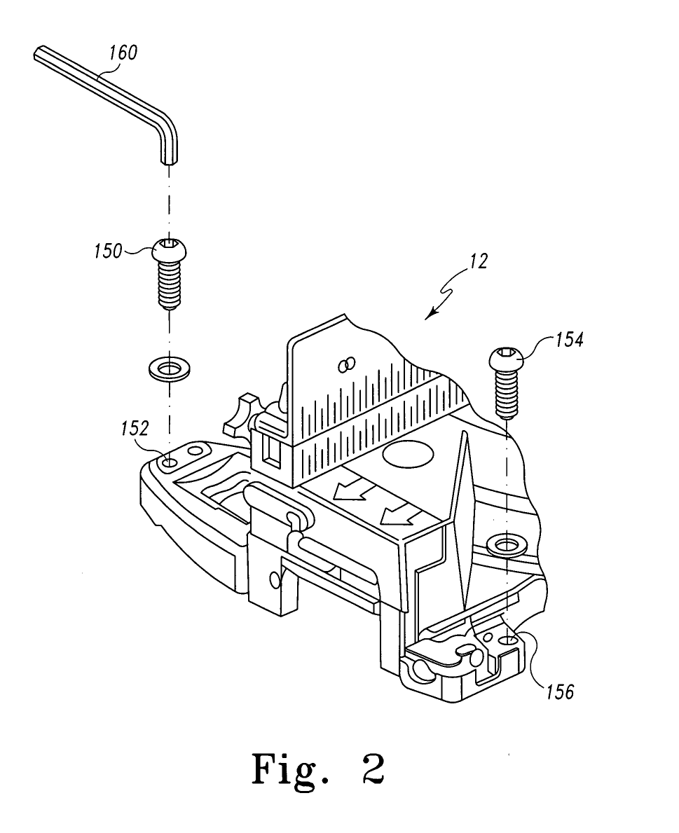

In order to secure one side of the power tool 12 to one of the tool mounts 10, the power tool 12 and/or the tool mount 10 is manipulated until a passage 152 (see FIGS. 1 and 2) defined in the base of the power tool 12 is aligned with the threaded opening 121 of the movable member 120. Similarly, another passage 156 defined in the base of the power tool 12 is aligned with the threaded opening 112 (or 114) of the movable member 100. It should be appreciated that each of the movable members 100,120 may need to be moved in relation to the body 20 in order to align the threaded openings 121,112 (or 114) with the passages 152, 156. Thereafter, a fastener 150 is advanced through the passage 152 and threadingly advanced into the threaded passage 121 by a driver 160 such as an Allen wrench until the fastener 150 is tightened down. Similarly, another fastener 154 is advanced through the passage 156 and threadingly advanced into the threaded passage 112 (or 114) by the driver 160 until the fastener is tightened down. The other side of the power tool 12 is secured to the other tool mount 10 in an identical manner.

There is a plurality of advantages arising from the various features of each of the embodiments of the tool mount described herein. It will be noted that alternative embodiments of the tool mount may not include all of the features described yet still benefit from at least some of the advantages of such features. Those of ordinary skill in the art may readily devise their own implementations of the tool mount that incorporates one or more of the features and fall within the spirit and scope of the present invention as defined by the appended claims.

What is claimed is:

1. A tool mount adapted to be attached to a support structure, comprising:
a body;
a clamping mechanism configured to secure said body to said support structure;
a first member defining a first internally threaded passage, said first member being movable in relation to said body along a linear path of movement; and
a second member defining a second internally threaded passage, said second member being pivotably secured to said body.

2. The tool mount of claim 1, wherein:
said body has a first slot defined therein;
said first internally threaded passage is continuously aligned with said first slot during movement of said first member in said linear path of movement.

3. The tool mount of claim 2, wherein:
said body has a second slot defined therein;
said second internally threaded passage is continuously aligned with said second slot during movement of said second member in an arcuate path of movement.

4. The tool mount of claim 1, further comprising a retainer structure secured to said body, wherein:
said first member includes (i) a first lateral portion positioned on a first side of said first internally threaded passage, and (ii) a second lateral portion positioned on a second side of said first internally threaded passage, and
said first lateral portion is interposed between said body and said retainer structure during movement of said first member in said linear path of movement, and (ii) said second lateral portion is interposed between said body and said retainer structure during movement of said first member in said linear path of movement.

5. The tool mount of claim 1, wherein:
said retainer structure defines a first slot, and
said first member further includes a first follower positioned in said first slot during movement of said first member in said linear path of movement.

6. The tool mount of claim 5, wherein:
said body defines a second slot, and
said first member further includes a second follower positioned in said second slot during movement of said first member in said linear path of movement.

7. The tool mount of claim 6, wherein said first internally threaded passage extends through both said first follower and said second follower.

8. The tool mount of claim 1, wherein said clamping mechanism includes:
a first jaw that is fixed in relation to said body, and
a second jaw that is movable in relation to said body.

9. The tool mount of claim 8, wherein:
said body includes a first downwardly extending member and a second downwardly extending member spaced apart from each other to define a gap,
said first jaw includes a first clamping surface and said second jaw includes a second clamping surface,
said first clamping surface and said second clamping surface are both configured to contact said support structure when said body is secured to said support structure, and
said second clamping surface of said second jaw is positioned within said gap during a first extent of movement of said second jaw in relation to said body.

10. The tool mount of claim 9, wherein said second clamping surface of said second jaw is spaced apart from said gap during a second extent of movement of said second jaw in relation to said body.

11. A tool mount adapted to be attached to a support structure, comprising:
a body having a first slot defined therein;
a clamping mechanism configured to secure said body to said support structure;
a first member defining a first internally threaded passage, said first member being movable in relation to said body along a linear path of movement, and said first internally threaded passage being continuously aligned with said first slot during movement of said first member in relation to said body along said linear path of movement; and
a second member defining a second internally threaded passage, said second member being movable in relation to said body.

12. The tool mount of claim 11, wherein:
said body has a second slot defined therein;
said second internally threaded passage is continuously aligned with said second slot during movement of said second member in an arcuate path of movement.

13. The tool mount of claim 11, further comprising a retainer structure secured to said body, wherein:
said first member includes (i) a first lateral portion positioned on a first side of said first internally threaded passage, and (ii) a second lateral portion positioned on a second side of said first internally threaded passage, and
said first lateral portion is interposed between said body and said retainer structure during movement of said first member in said linear path of movement, and (ii) said second lateral portion is interposed between said body and said retainer structure during movement of said first member in said linear path of movement.

14. The tool mount of claim 11, wherein:
said retainer structure defines a second slot, and
said first member further includes a first follower positioned in said second slot of said retainer structure during movement of said first member in said linear path of movement.

15. The tool mount of claim 14, wherein:
said first member further includes a second follower positioned in said first slot of said body during movement of said first member in said linear path of movement.

16. The tool mount of claim 15, wherein said first internally threaded passage extends through both said first follower and said second follower.

17. The tool mount of claim 11, wherein said clamping mechanism includes:
a first jaw that is fixed in relation to said body, and
a second jaw that is movable in relation to said body.

18. The tool mount of claim 17, wherein:
said body includes a first downwardly extending member and a second downwardly extending member spaced apart from each other to define a gap,
said first jaw includes a first clamping surface and said second jaw includes a second clamping surface,
said first clamping surface and said second clamping surface are both configured to contact said support structure when said body is secured to said support structure, and
said second clamping surface of said second jaw is positioned within said gap during a first extent of movement of said second jaw in relation to said body.

19. The tool mount of claim 18, wherein said second clamping surface of said second jaw is spaced apart from said gap during a second extent of movement of said second jaw in relation to said body.

20. A tool mount adapted to be attached to a support structure, comprising:
an elongate body defining a width and a length;
a clamping mechanism configured to secure said body to said support structure;
a first member including a first coupling component, said first member being movable in relation to said body in a lengthwise direction in relation to said body; and
a second member including a second coupling component, said second member being movable in relation to said body in a widthwise direction in relation to said body.

21. The tool mount of claim 20, wherein:
said body has a first slot defined therein;
said first coupling component includes a first internally threaded passage, and
said first internally threaded passage is continuously aligned with said first slot during movement of said first member in said lengthwise direction in relation to said body.

22. The tool mount of claim 21, wherein:
said body has a second slot defined therein;
said second coupling component includes a second internally threaded passage, and
said second internally threaded passage is continuously aligned with said second slot during movement of said second member in said widthwise direction in relation to said body.

23. The tool mount of claim 20, further comprising a retainer structure secured to said body, wherein:
said first member includes (i) a first lateral portion positioned on a first side of said first internally threaded passage, and (ii) a second lateral portion positioned on a second side of said first internally threaded passage, and
said first lateral portion is interposed between said body and said retainer structure during movement of said first member in said lengthwise direction in relation to said body, and (ii) said second lateral portion is interposed between said body and said retainer structure during movement of said first member in said lengthwise direction in relation to said body.

24. The tool mount of claim 20, wherein:
said retainer structure defines a first slot, and
said first member further includes a first follower positioned in said first slot during movement of said first member in said lengthwise direction in relation to said body.

25. The tool mount of claim 24, wherein:
said body defines a second slot, and
said first member further includes a second follower positioned in said second slot during movement of said first member in said lengthwise direction in relation to said body.

26. The tool mount of claim 25, wherein:
said first coupling component includes a first internally threaded passage, and
said first internally threaded passage extends through both said first follower and said second follower.

27. The tool mount of claim 20, wherein said clamping mechanism includes:
a first jaw that is fixed in relation to said body, and
a second jaw that is movable in relation to said body.

28. The tool mount of claim 27, wherein:
said body includes a first downwardly extending member and a second downwardly extending member spaced apart from each other to define a gap,
said first jaw includes a first clamping surface and said second jaw includes a second clamping surface,
said first clamping surface and said second clamping surface are both configured to contact said support structure when said body is secured to said support structure, and
said second clamping surface of said second jaw is positioned within said gap during a first extent of movement of said second jaw in relation to said body.

29. The tool mount of claim 28, wherein said second clamping surface of said second jaw is spaced apart from said gap during a second extent of movement of said second jaw in relation to said body.
